(19) United States
(12) Patent Application Publication
(10) Pub. No.: US 2009/0077890 A1
(43) Pub. Date: Mar. 26, 2009

(54) FOUR-STAGE STEAM REFORMER

(75) Inventor: Stanley R. Pearson, Baton Rouge, LA (US)

Correspondence Address: KEAN, MILLER, HAWTHORNE, D'ARMOND,;MCCOWAN & JARMAN, L.L.P., ONE AMERICAN PLACE, 22ND FLOOR, P.O. BOX 3513, BATON ROUGE, LA, 70821, US

(73) Assignee: International Financial Services #1, LLC, Baton Rouge, LA (US)

(21) Appl. No.: 12/237,950

(22) Filed: Sep. 25, 2008

Related U.S. Application Data
(60) Provisional application No. 60/995,191, filed on Sep. 25, 2007.

(51) Int. Cl. B01J 19/00

(52) U.S. Cl. 48/127.9

(57) ABSTRACT

A four stage steam reformer suitable for producing a synthetic gaseous stream from a carbonaceous feedstock. Each stage is capable of operating at a progressively higher temperature than the immediate preceding stage.

### CROSS-REFERENCE TO RELATED APPLICATIONS

This application is based on Provisional Application U.S. Ser. No. 60/995,191 filed Sep. 25, 2007.

### FIELD OF THE INVENTION

The present invention relates to a four stage steam reformer suitable for producing a synthetic gaseous stream from a feedstock comprised of a carbonaceous material. Each stage is capable of operating at a progressively higher temperature than the immediate preceding stage.

### BACKGROUND OF THE INVENTION

The steam reforming of carbonaceous materials into carbon oxides and hydrogen is the heart of synthesis gas plants, particularly hydrogen-rich gas plants. The technology has been known for many decades and new developments are continually being made, both in equipment and related catalyst technology. Steam reforming technologies can generally be distinguished by the type of heat input. Such technologies include adiabatic (prereforming), convection heat transfer, radiant heat transfer (side fired tubular reformer), and internal combustion (autothermal reformer).

Until recently most steam reforming technology was used for reforming methane to produce methanol. There has been substantial activity in recent years in the field of biofuels, such as the production of ethanol from a biomass, such as corn. There is also interest in producing ethanol and ethylene from coal using a steam reformer as disclosed in co-pending U.S. Patent Application filed concurrent with this application and having an attorney docket number of 196353, and based on U.S. Provisional Application 60/995,192 which was filed Sep. 25, 2007 and which is incorporated herein by reference.

While conventional reformer technology has met with a commercial success for converting biomass to synthetic gas, there are problems associated with effectively converting such feedstocks to synthetic gas without undesirable side reactions occurring. Therefore, there is a need in the art for improved steam reforming technology to accommodate complex biomass feedstocks.

### SUMMARY OF THE INVENTION

In accordance with the present invention there is provided a four stage steam reformer comprising:

a) a first reactor vessel comprised of an enclosing wall thereby defining an enclosure, a first inlet to the interior of said enclosure, a first outlet leading out of said interior of said enclosure, an tubular arrangement having a first end and a second end and secured within said interior of said enclosure which first end is fluidly connected to an inlet port of said enclosing wall and said second end fluidly connected to an outlet port of said enclosing wall;

b) a second stage reactor vessel fluidly connected to said outlet port of said enclosing wall of said first stage reactor vessel at an inlet which is comprised of a plurality of flow divider tubes and which is secured to the underside of said second stage reactor vessel which is cylindrical in shape and wherein each divider tube is fluidly connected to a reaction tube that extends vertically throughout said second reactor vessel and further extending through a top plate of said second reactor vessel;

c) a third stage reactor vessel which is cylindrical in shape and which contains a plurality of vertically oriented reaction tubes each fluidly connected to a vertically oriented reactor tube of said second reactor vessel and extending through a bottom plate of said third reactor vessel, which third reactor vessel contains a burner at its bottom for providing heat to all of stage 1, stage 2 and stage 3 reaction vessels;

d) a manifold having a inlet and an outlet wherein said inlet is in fluid communication with the plurality of reactor tubes extending through the bottom of said third reactor vessel whose outlet is a single port;

e) a fourth stage reactor vessel which is cylindrical in shape and which has a first inlet in fluid communication with said outlet port of said manifold and a second inlet which is in fluid communication with said first inlet, which fourth stage reactor vessel also contains a an outlet port for exhausting flue gas and an outlet for removing solids.

### BRIEF DESCRIPTION OF THE FIGURES

FIG. 1 hereof is a schematic of a preferred four stage reformer of the present invention.

FIG. 2 hereof is a view, along plane A-A, of the stages 1 and 2 of the reformer system of the present invention.

### DETAILED DESCRIPTION OF THE INVENTION

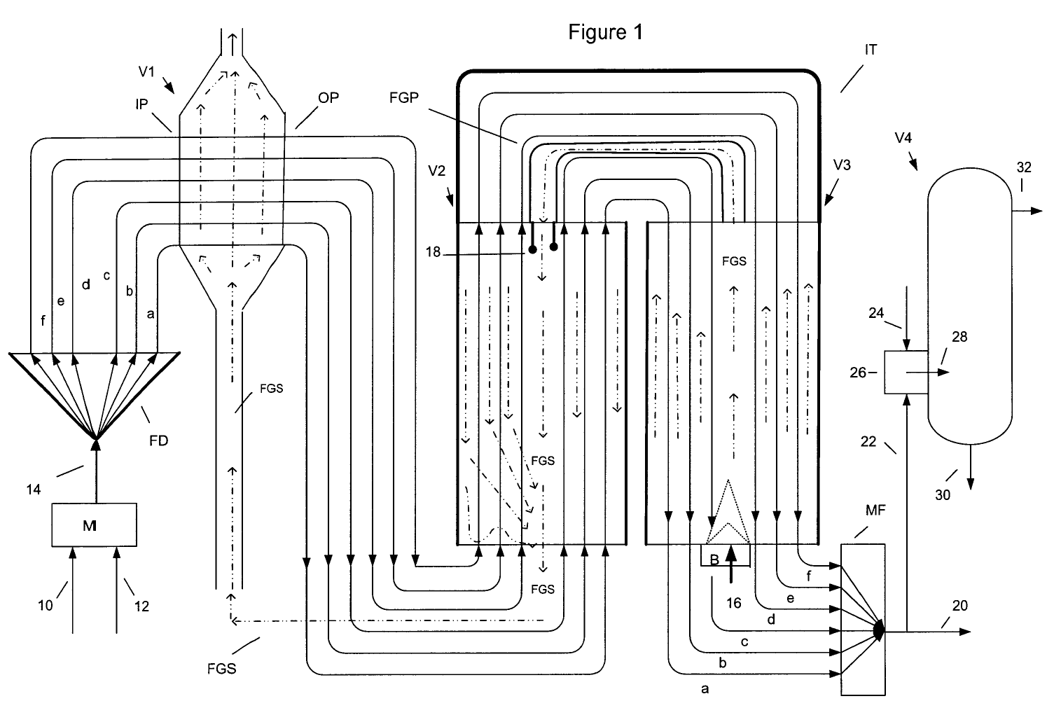

Referring to FIG. 1 hereof, there is shown a four stage steam reformer reactor system of the present invention for reforming a carbonaceous material feedstock to produce a synthesis gas. The term “carbonaceous material” is a material that is rich in carbon such as hydrocarbons, coal-based products, and petroleum-based products. The term “hydrocarbon” as used herein includes materials typically also referred to as “hydrocarbonaceous”, which materials are comprised primarily of hydrogen, carbon and oxygen, but which also contains other elements as well such as the heteroatoms oxygen, sulfur and nitrogen. Non-limiting examples of feedstocks suitable for use with the four stage reformer reactor system of the present invention include coal, oil-shale, and biomass. Non-limiting examples of biomass materials suitable for use herein include corn, molasses, agricultural waste, forest residue, municipal solid waste, and energy crops. Agricultural waste includes crop residues such as wheat straw, corn stover (leaves, stalks, and cobs), rice straw, and bagasse (sugar cane waste). Forestry residue includes underutilized wood and logging residues, rough, rotten, and salvable dead wood; and excess saplings and small trees. Municipal solid waste contains some cellulosic materials, such as paper. Energy crops, developed and grown specifically for fuel include fast-growing trees, shrubs, and grasses such as hybrid poplars, willows, and switchgrass. Preferred biomass materials include corn and blackstrap molasses. Blackstrap molasses is a thick syrup by-product obtained from the processing of sugarcane or sugar beet into sugar.

FIG. 1 shows the four stages as separate reactor vessels each in fluid communication with the next downstream and upstream vessel. By four stages we mean four temperature stages in series with each stage operated at a higher temperature than the immediate preceeding stage. By downstream we mean with respect to the direction that a feedstock will progress through the series of reactor vessels from the first stage to the fourth stage. The fourth stage preferably has the ability to switch out with an autothermal type of stage for treating feedstock having a very low reactivity and requiring extremely high conversion temperatures. A suitable feedstock is introduced via line 10 into mixing zone M along with an effective amount steam, preferably superheated steam, that is introduced via line 12. Any suitable feedstock can be used in the practice of the present invention. Non-limiting examples of types of hydrocarbon feedstocks that can be used include any of the coals, from lignite to anthracite; cellulosic materials, preferably wood; agricultural products, preferably corn; alcohols, preferably methanol; and alkanes, preferably methane, butane and propane. The mixture is divided into a predetermined number of feed streams, depending primarily on the type of feedstock and the size of the reactor vessels. The feed mixture is conducted via line 14 from mixing zone M to flow divider FD. Flow dividers are well known to those having at least ordinary skill in the art and thus there is no need to discuss them in detail herein. Each stream is conducted via feed tubes a-f to inlet ports IP on the side of the reactor vessel V1. It is preferred that all reactor vessels of this invention be cylindrical in shape. All construction materials, including reactor vessels and reactor tubes through which the feedstock passes through the four stages are manufactured from high temperature alloys suitable for the temperatures and conditions of the particular reactor vessel in which they are located. It is preferred that the reactor tubes be cast tubes comprised of a high temperature alloy. It has been found by the inventor hereof that cast alloy feed tubes are able to withstand the environment of the reactor vessels of the present invention better than extruded or rolled tubes. Therefore, cast feed tubes are preferred.

The divided feedstreams are transported through reactor vessel V1 through feed tubes and are fluidly connected to outlet ports OP which are fluidly connected to feed tubes within the interior of reactor vessel V1. In fact, all individual feed tubes are fluidly connected from the flow divider FD to manifold MF. Reactor vessel V1 is preferably a shell and tube type vessel and will be run during the stream reforming reaction at a temperature from about 650° F. to about 800° F. The heat used to run reactor vessel V1 is derived from flue gas stream FGS that originates in stage 3 reactor vessel V3 by burner B which is fueled via line 16 preferably with natural gas, or a portion of the synthesis gas produced in the apparatus of the present invention. Feed tubes exit reactor vessel V1 at outlet ports OP and are fluidly connected to inlet ports at the bottom of stage 2 reactor vessel V2 which are fluidly connected to a plurality of feed tubes extending vertically throughout the length of reactor vessel V2. Reactor vessel V2 will be operated in the temperature range of about 1300° F. to about 1450° F. The heat to run reactor vessel V2 is also obtained from the flue gas stream FGS produced by burner B located at the bottom of reactor vessel V3. In the event flue gas stream FGS does not provide an adequate amount of heat to maintain reactor vessel at a temperature from about 1300° F. to about 1450° F. trim burner 18 may be used to add heat to flue gas stream FGS. It is preferred that trim burner 18 also be fueled by use of natural gas or a portion of the product synthesis gas stream. It is also preferred that the trim burner be an annular shaped burner situated on the perimeter of the opening of flue gas pipe FGP which is fluidly connected to the top of reactor vessel V2 to receive flue gas from reactor vessel V3.

The reaction product of reactor vessel V2 continues flowing downstream through a plurality of feed tubes that fluidly connect vertically oriented feed tubes in reactor vessel V2 and the plurality of feed tubes vertically oriented in reactor vessel V3. Reactor vessel V3 is operated at a temperature in the range of about 1450° F. to about 1750° F. where further reaction of the hydrocarbons in the reaction product from V2 takes place. An insulating top, or cover, IT is provided that encloses the tops of reactor vessels V2 and V3 to prevent an undesirable amount of heat loss from feed tubes extending from reactor vessel V2 to V3. The tubular members exit the bottom the reactor vessel V3 and into manifold MF where the reaction product streams are combined and exit manifold MF via line 20. If a feedstock, such as natural gas or methanol, is used and the steam reforming reaction is completed in reactor vessel V3, the product synthesis gas can be collected and stored or sent for further downstream processing. If the hydrocarbon feedstock is relatively refractory and contains a high carbon content, such as anthracite, then the reaction product exiting manifold MF is sent via line 22 to a fourth stage reactor vessel V4 by first conducting it to a mixer 26 where it is mixed with an effective amount of an oxygen-containing gas, preferably substantially pure oxygen via line 24. It will be understood that mixer 26 can be either external or internal to reactor vessel V4. It is preferred that it be external. The mixture of reaction product from reactor vessel V3 and oxygen-containing gas enter reactor vessel V4 at 28 where it further combusts at temperatures from about 1750° F. to about 2100° F., preferably at a temperature from about 1800° F. to about 2000° F. The final reaction product synthesis gas exits the four stage steam reformer at outlet 32 and is collected and stored, or transported off site, or passed to a downstream process unit for further processing. Such further processing can include syn gas clean-up technology as described in U.S. Pat. No. 7,375,142 which is incorporated herein by reference to produce a clean product that can be used to further process into synthetic natural gas, alcohols, and hydrocarbons.

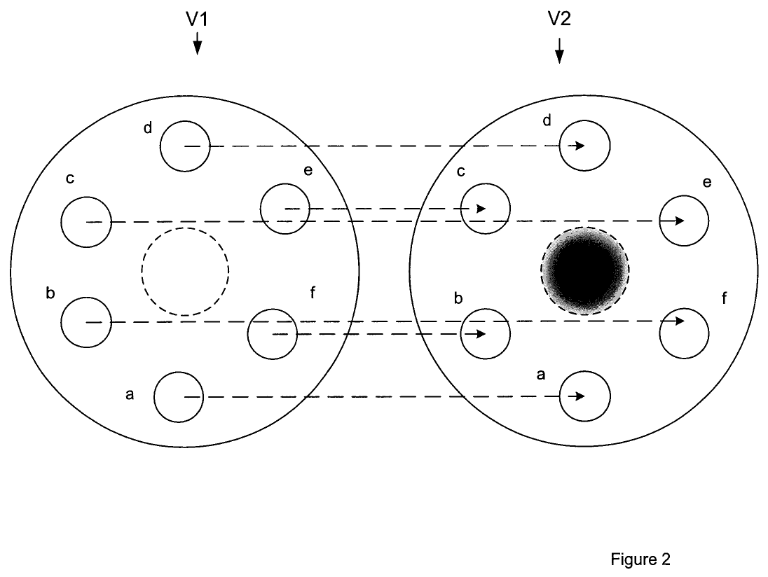

FIG. 2 hereof is a cross-sectional view along A-A of FIG. 1 hereof showing base plates BP2 and BP3 for reactor vessels V2 and V3 respectively. Also shown reactively for each reactor vessels V2 and V3 are outside walls W2 and W3 and tubular members a, b c, d, e, and f. Tubular members a, b, c, d, e, and f extend vertically upward from base plate BP2 and to reactor vessel R3 where they extend vertically downward to based plate BP3. FL is the flame from burner B.

What is claimed is:

1. A four stage steam reformer comprising:
a) a first reactor vessel comprised of an enclosing wall thereby defining an enclosure, a first inlet to the interior of said enclosure, a first outlet leading out of said interior of said enclosure, an tubular arrangement having a first end and a second end and secured within said interior of said enclosure which first end is fluidly connected to an inlet port of said enclosing wall and said second end fluidly connected to an outlet port of said enclosing wall;
b) a second stage reactor vessel fluidly connected to said outlet port of said enclosing wall of said first stage reactor vessel at an inlet which is comprised of a plurality of flow divider tubes and which is secured to the underside of said second stage reactor vessel which is cylindrical in shape and wherein each divider tube is fluidly connected to a reaction tube that extends vertically throughout said second reactor vessel and further extending through a top plate of said second reactor vessel;
c) a third stage reactor vessel which is cylindrical in shape and which contains a plurality of vertically oriented reaction tubes each fluidly connected to a vertically oriented reactor tube of said second reactor vessel and extending through a bottom plate of said third reactor vessel, which third reactor vessel contains a burner at its bottom for providing heat to all of stage 1, stage 2 and stage 3 reaction vessels;
d) a manifold having a inlet and an outlet wherein said inlet is in fluid communication with the plurality of reactor tubes extending through the bottom of said third reactor vessel whose outlet is a single port;
e) a fourth stage reactor vessel which is cylindrical in shape and which has a first inlet in fluid communication with said outlet port of said manifold and a second inlet which is in fluid communication with said first inlet, which fourth stage reactor vessel also contains a an outlet port for exhausting flue gas and an outlet for removing solids.

2. The four stage steam reformer of claim 1 wherein at least one of the first stage reactor vessel, the second stage reactor vessel, and the third stage reactor vessel is a shell and tube type of vessel.

3. The four stage steam reformer of claim 1 wherein the first stage reactor vessel is capable of being operated in the temperature range of about 650° F. to about 800° F.

4. The four stage steam reformer of claim 3 wherein the second stage reactor vessel is capable of being operated in the temperature range of about 1300° F. to about 1450° F.

5. The four stage steam reformer of claim 4 wherein the third stage reactor vessel is capable of being operated in the temperature range of about 1450° F. to about 1750° F.

6. The four stage steam reformer of claim 5 wherein the fourth stage reactor vessel is capable of being operated in the temperature range of about 1750° F. to about 2100° F.

7. The four stage steam reformer of claim 1 wherein upstream of said first stage reactor vessel there is provided an apparatus capable of dividing a feedstock in multiple streams.

8. The four stage steam reformer of claim 1 wherein said third stage reactor vessel contains an interior volume and wherein a burner is provided at the bottom of said third reactor vessel for supplying heat of reaction to the interior volume of said third reactor vessel through-which the reaction tubes are contained.

9. The four stage steam reformer of claim 8 wherein the first stage reactor vessel and the second stage reactor vessel also contain an interior volume both of which are in fluid communication with the interior volume of said third stage reactor vessel.
